(19) United States
(12) Patent Application Publication
(10) Pub. No.: US 2023/0278420 A1
(43) Pub. Date: Sep. 7, 2023

(54) FUEL FILL ADAPTOR ASSEMBLY FOR VEHICLE BODY

(71) Applicant: The Knapheide Manufacturing Company, Quincy, IL (US)

(72) Inventor: Justin Steele, Quincy, IL (US)

(73) Assignee: The Knapheide Manufacturing Company, Quincy, IL (US)

(21) Appl. No.: 18/179,615

(22) Filed: Mar. 7, 2023

Related U.S. Application Data
(60) Provisional application No. 63/317,532, filed on Mar. 7, 2022.

(51) Int. Cl. B60K 15/05

(52) U.S. Cl. CPC B60K 15/05; B60K 2015/0553

(57) ABSTRACT

A fuel fill adaptor assembly includes a fill housing, a cover assembly for selectively preventing access to an interior of the fill housing, and a mounting plate for mounting the fuel fill adaptor assembly to a terminal portion of a fuel tank assembly of a vehicle. The mounting plate can mounted to the fill housing in one of a variety of different mounting positions to be suitable for use with at least two different vehicles. The mounting plate can be configured to be connectable to at least two different fill necks having different mounting configurations.

### CROSS-REFERENCE TO RELATED APPLICATIONS

This patent application claims the benefit of priority to U.S. Provisional Pat. Application No. 63/317,532, filed Mar. 7, 2022, and entitled, “Fuel Fill Adaptor Assembly for Vehicle Body,” which is incorporated in its entirety herein by this reference.

### TECHNICAL FIELD

This patent disclosure relates generally to a fuel fill adaptor assembly and, more particularly, to a fuel fill adaptor assembly for a vehicle body suitable for use with a variety of fuel tank arrangements.

### BACKGROUND

A service body configured for use by a tradesman can be added to a vehicle to enhance its usefulness for safely storing equipment commonly used by the tradesman in carrying out his vocation. When mounting a service body to a vehicle, the installer provides means for allowing access to the fill port of the fuel tank of the vehicle. Different fuel tank configurations are in use in different commercially-available vehicles. As a result, the installer can be confronted with a variety of unique mounting arrangements for providing fuel fill access.

Typically, the hole in the service body for a fuel fill adaptor is cut in the field by the installer depending upon to what vehicle the service body is being mounted. A different fuel adaptor is used depending upon the particular make and model of the vehicle.

There is a continued need in the art to provide additional solutions to enhance the use and installation of service bodies with vehicles over a range of conditions. For example, there is a continued need for a fuel fill adaptor that can be used with a variety of fuel tank assembly configurations.

It will be appreciated that this background description has been provided to aid the reader, and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims, and not by the ability of any disclosed feature to solve any specific problem noted herein.

### SUMMARY

The present disclosure, in one aspect, is directed to embodiments of a fuel fill adaptor assembly. In embodiments, a fuel fill adaptor assembly includes a fill housing, a cover assembly for selectively preventing access to an interior of the fill housing, and a mounting plate for mounting the fuel fill adaptor assembly to a terminal portion of a fuel tank assembly of a vehicle.

In one embodiment, a fill housing, a cover assembly, and a mounting plate. The fill housing defines a fill end, an interior cavity, and a tank end. The fill end includes a mounting flange defining a fill opening in communication with the interior cavity. The tank end defines a mounting opening in communication with the interior cavity. The cover assembly is for selectively preventing access to the interior cavity of the fill housing via the fill opening. The mounting plate is mounted to the fill housing adjacent the tank end in one of a plurality of mounting positions. The mounting plate is configured to be connectable to at least two types of a terminal portion of a fuel tank assembly having different mounting configurations.

In still another aspect, embodiments of a service body for a vehicle are disclosed. In embodiments, a service body includes an embodiment of a fuel fill adaptor assembly constructed according to principles of the present disclosure.

In one embodiment, a service body for a vehicle includes a service body panel and a fuel fill adaptor assembly. The service body panel has an interior surface and an exterior surface with a cutout extending therethrough.

The fuel fill adaptor assembly includes a fill housing, a cover assembly, and a mounting plate. The fill housing defines a fill end, an interior cavity, and a tank end. The fill end includes a mounting flange defining a fill opening in communication with the interior cavity. The tank end defines a mounting opening in communication with the interior cavity. The cover assembly is for selectively preventing access to the interior cavity of the fill housing via the fill opening. The mounting plate is mounted to the fill housing adjacent the tank end in one of a plurality of mounting positions. The mounting plate is configured to be connectable to at least two types of a terminal portion of a fuel tank assembly having different mounting configurations.

The cover assembly includes a frame and a fill door pivotally connected to the frame. The frame is attached to the mounting flange of the fill housing such that the service body panel is interposed between the frame and the mounting flange. The frame defines a central fill port therethrough. The central fill port is aligned with the cutout. The fill door is pivotally movable over a range of travel between a closed position in which the cutout and the fill port are occluded and access to the interior cavity of the fill housing via the fill opening is blocked and an open position in which the door is moved away from the fill port such that the interior cavity of the fill housing is accessible through the fill opening and the cutout.

Further and alternative aspects and features of the disclosed principles will be appreciated from the following detailed description and the accompanying drawings. As will be appreciated, the fuel fill adaptor assemblies and service bodies for vehicles disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is an exploded view of an embodiment of a fuel fill adaptor assembly constructed in accordance with principles of the present disclosure, the fuel fill adaptor assembly including a fill housing, a cover assembly, and a mounting plate.

FIG. 2 is a perspective view of the fuel fill adaptor assembly of FIG. 1.

FIG. 3 is a perspective view of another embodiment of a fuel fill adaptor assembly constructed in accordance with principles of the present disclosure.

FIG. 4 is an exploded view, from an exterior face thereof, of portions of the cover assembly of the fuel fill adaptor assembly of FIG. 1.

FIG. 5 is an exploded view of portions of the cover assembly of the fuel fill adaptor assembly of FIG. 1 as in FIG. 4 but from an interior face thereof.

FIG. 6 is an enlarged, fragmentary detail view, of a frame and a perspective view of a mounting pin of the cover assembly, illustrating the pivotal connection of a fill door to the frame.

FIGS. 7-9 are transverse sectional views through the pivotal connection of the fill door to the frame of the cover assembly if FIG. 1, illustrating the fill door in a closed position in FIGS. 7 and 8 and an open position in FIG. 9. FIG. 7 illustrates the interference between the fill door and a resilient catch of the frame when the fill door is in the closed position. FIG. 8 illustrates the displacement of the resilient catch by placing the fill door in the closed position to provide a detent feature. FIG. 9 illustrates the interference between the fill door and a resilient catch of the frame when the fill door is in the open position.

FIG. 10 is a plan view of a first face of the mounting plate of the fuel fill adaptor assembly of FIG. 1.

FIG. 11 is a side elevational view of the mounting plate of the fuel fill adaptor assembly of FIG. 1.

FIG. 12 is a plan view of a second face of the mounting plate of the fuel fill adaptor assembly of FIG. 1.

FIG. 13 is a side elevational view of the fill housing and the mounting plate of the fuel fill adaptor assembly of FIG. 1.

FIG. 14 is a perspective view, from an exterior face thereof, of the fill housing and the mounting plate of the fuel fill adaptor assembly of FIG. 1, illustrating the connection of the mounting plate to the fill housing.

FIG. 15 is an elevational view, from an interior face thereof, of the fill housing and the mounting plate of the fuel fill adaptor assembly of FIG. 1, illustrating the connection of the mounting plate to the fill housing via a pin.

FIG. 16 is a side elevational view of the fill housing and the mounting plate of the fuel fill adaptor assembly of FIG. 1, illustrating the connection of the mounting plate to the fill housing such that the mounting plate is disposed at a first angle with respect to a fill end of the fill housing.

FIG. 17 is a side elevational view of the fill housing and the mounting plate of the fuel fill adaptor as in FIG. 16, illustrating the connection of the mounting plate to the fill housing such that the mounting plate is disposed at a second angle with respect to the fill end of the fill housing which is greater than the first angle.

FIG. 18 is a side elevational view of the fill housing and the mounting plate of the fuel fill adaptor as in FIG. 16, illustrating the connection of the mounting plate to the fill housing such that the mounting plate is disposed at a third angle with respect to the fill end of the fill housing, which is greater than the first angle and the second angle.

FIG. 19 is a side elevational view of a fill housing and a mounting plate of the fuel fill adaptor assembly of FIG. 3, illustrating the connection of the mounting plate to the fill housing such that the first face of the mounting plate faces toward the fill end, and away from the tank end, of the fill housing such that the mounting plate is disposed at a fourth angle with respect to the fill end of the fill housing.

FIG. 20 is a side elevational view of a fill housing and a mounting plate of the fuel fill adaptor assembly of FIG. 3, illustrating the connection of the mounting plate to the fill housing such that the second face of the mounting plate faces toward the fill end, and away from the tank end, of the fill housing such that the mounting plate is disposed at a fifth angle with respect to the fill end of the fill housing, which is smaller than the fourth angle.

FIG. 21 is a fragmentary, view of an embodiment of a vehicle, the vehicle including the fuel fill adaptor assembly of FIG. 1 mounted to an embodiment of a service body.

FIG. 22 is a view of vehicle of FIG. 21, with components removed for illustrative purposes to depict the connection of the fuel fill adaptor assembly to a fuel tank of the vehicle.

FIG. 23 is an enlarged, fragmentary view of the fuel fill adaptor assembly as in FIG. 22, illustrating a fill neck of the fuel fill line leading to the fuel tank line attached to the mounting plate of the fuel fill adaptor assembly.

FIG. 24 is an elevational view, from an exterior face thereof, of the fuel fill adaptor assembly as in FIG. 23, with the fill door removed for illustrative purposes and depicting a cap removably secured to the fill neck.

FIGS. 25 and 26 are views, from the first face and the second face, respectively, of the mounting plate of the fuel fill adaptor assembly of FIG. 1 mounted to an embodiment of a fill neck via a first set of a plurality of mounting apertures defined in the mounting plate.

FIGS. 27 and 28 are views, from the first face and the second face, respectively, of the mounting plate of the fuel fill adaptor assembly of FIG. 1 mounted to another embodiment of a fill neck via a second set of the mounting apertures defined in the mounting plate.

FIGS. 29 and 30 are views, from the first face and the second face, respectively, of the mounting plate of the fuel fill adaptor assembly of FIG. 1 mounted to another embodiment of a fill neck via a third set of the mounting apertures defined in the mounting plate.

It should be understood that the drawings are not necessarily to scale and that the disclosed embodiments are illustrated diagrammatically and in partial views. In certain instances, details which are not necessary for an understanding of this disclosure or which render other details difficult to perceive may have been omitted. It should be understood that this disclosure is not limited to the particular embodiments illustrated herein.

### DETAILED DESCRIPTION OF EXEMPLARY EMBODIMENTS

Embodiments of a fuel fill adaptor assembly constructed in accordance with principles of the present disclosure can be used as a “universal” fuel fill adaptor assembly, i.e., configured to be used with at least two different fuel tank arrangements with different fuel fill lines in communication with the respective tanks. Embodiments of a fuel fill adaptor assembly constructed in accordance with principles of the present disclosure can be used to provide access to the fuel tank of a vehicle having an after-market service body mounted thereto.

In embodiments, the fuel fill adaptor assembly includes a fill housing, a cover assembly for selectively preventing access to an interior cavity of the fill housing via a fill opening of the fill housing, and a mounting plate for mounting the fuel fill adaptor assembly to a terminal portion of a fuel tank assembly of a vehicle. The mounting plate can be configured to be connectable to at least two different fill necks having different mounting configurations. The mounting plate can be configured to be mounted to the fill housing in one of a variety of different mounting positions to be suitable for use with at least two different vehicles.

Embodiments of a fuel fill adaptor assembly constructed in accordance with principles of the present disclosure include means for respectively mounting a plurality of different fill necks thereto. In embodiments, the means for respectively mounting a plurality of different fill necks thereto includes a mounting plate defining a plurality of mounting apertures therein. In embodiments, each one of the different fill necks can be mounted to the mounting plate via a subset of the mounting apertures defined therein. In embodiments, the fuel fill adaptor can be used with fill necks having different mounting structure.

Embodiments of a fuel fill adaptor assembly constructed in accordance with principles of the present disclosure include means for respectively mounting a fill neck thereto over a range of different orientations with respect to a fill end of a fill housing of the fuel fill adaptor assembly such that the fuel fill adaptor assembly can be used with a variety of different commercially-available vehicle chasses. In embodiments, the means for respectively mounting a fill neck thereto over a range of different orientations with respect to a fill end of a fill housing of the fuel fill adaptor assembly includes a mounting plate having a pair of detent posts extending therefrom and a fill housing defining first and second series of detents in spaced relationship to each other. The mounting plate can be mounted to the fill body such that the detent posts are respectively disposed in one of the first and second series of such that the mounting plate is incrementally adjustable relative to the fill end of the fill housing. In embodiments, the fuel fill adaptor can be used with fuel tank arrangements which different fill neck orientations with respect to the fill end of the fill housing.

Embodiments of a fuel fill adaptor assembly constructed in accordance with principles of the present disclosure can have a wide variety of different forms, as will be appreciated by one skilled in the art. For example, in embodiments, a fuel fill adaptor assembly constructed according to principles of the present disclosure can include a fill housing having different shapes and configurations to be suitable for use with different fuel tank arrangements.

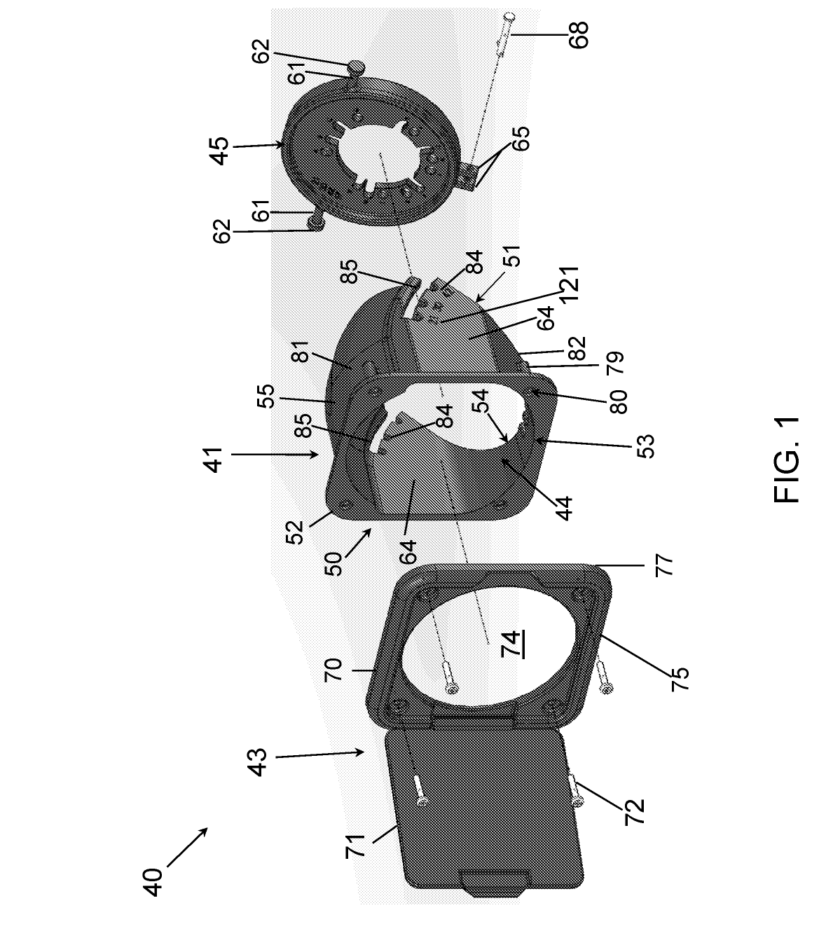

Turning now to the Figures, there is shown in FIG. 1 an embodiment of a fuel fill adaptor assembly 40 constructed according to principles of the present disclosure. The illustrated fuel fill adaptor assembly 40 includes a fill housing 41, a cover assembly 43 for selectively blocking access to an interior cavity 44 of the fill housing 41, and a mounting plate 45 for mounting the fuel fill adaptor assembly 40 to a terminal portion of a fuel tank assembly of a vehicle.

The fill housing 41 defines a fill end 50, a tank end 51, and the interior cavity 44, which is configured to receive a gas pump nozzle therein. The fill end 50 includes a mounting flange 52 defining a fill opening 53 in communication with the interior cavity 44. The tank end 51 defines a mounting opening 54 in communication with the interior cavity 44. In the illustrated embodiment, the mounting opening 54 is configured to accommodate the mounting plate 45 therethrough.

The fill housing 41 includes a shroud portion 55 extending between the fill end 50 and the tank end 51. The shroud portion 55 extends from the mounting flange 52 of the fill end 50 to the tank end 51 and defines the interior cavity 44.

The cover assembly 43 and the mounting plate 45 are respectively connected to opposing ends 50, 51 of the fill housing 41. The cover assembly 43 is configured to selectively prevent access to the interior cavity 44 of the fill housing 41 via the fill opening 53.

The mounting plate 45 includes a pair of detent posts 61 projecting therefrom which are configured to facilitate mounting the mounting plate 45 in one of a plurality of different angular tilt positions with respect to the fill housing 41. In the illustrated embodiment, each of the detent posts 61 of the mounting plate 45 includes a disc 62 extending radially from the post 61 and configured to act as a stop against the sidewall 64 through which the post 61 extends to capture the mounting plate 45 laterally with respect to the sidewalls of the fill housing 41. The mounting plate 45 includes a plurality of mounting fingers 65 extending therefrom which are configured to secure the mounting plate 45 to the fill housing 41 via a cotter pin 68.

The mounting plate 45 is mountable to the fill housing 41 adjacent the tank end 51 in one of a plurality of mounting positions. The mounting plate 45 is configured to be connectable to at least two types of a terminal portion of a fuel tank assembly (e.g., a fill neck) having different mounting configurations. The mounting plate 45 is configured to be mounted to the fill housing 41 adjacent the tank end 51 in one of a plurality of different mounting positions to be suitable for use with at least two different vehicles.

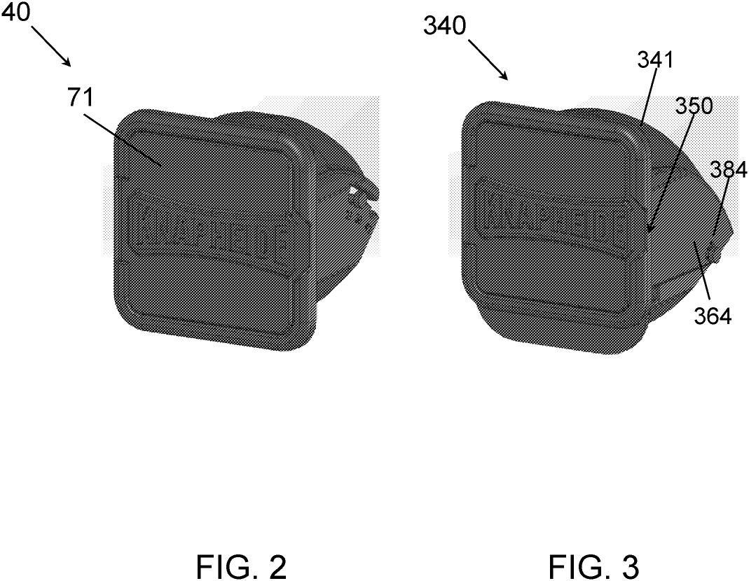

The illustrated cover assembly 43 includes a frame 70, a fill door 71 pivotally connected to the frame 70, and a plurality of fasteners 72 for securing the frame to the fill housing 41. In the illustrated embodiment, the frame 70 is generally rectangular and defines a central fill port 74 therethrough. The fill door 71 is pivotally movable over a range of travel between a closed position (as shown in FIG. 2) in which the fill port 74 is occluded and access to the interior cavity 44 of the fill housing 41 is blocked and an open position (as shown in FIG. 1) in which the fill door 71 is moved away from the fill port 74 such that access to the interior cavity 44 of the fill housing 41 is available.

Referring to FIG. 1, in the illustrated embodiment, the frame 70 has a two piece construction including a fill door mounting plate 75 and a backer plate 77. In embodiments, the fill door mounting plate 75 and the backer plate 77 can be made from different materials. In embodiments, the fill door mounting plate 75 can be made from a suitable plastic and the backer plate 77 can be made from a suitable metal to help add rigidity.

The mounting flange 52 of the fill end 50 defines a substantially planar mounting surface configured to be placed into abutment with a panel of a service body. In use, an installer can place the mounting flange 52 around a cutout in the panel of the service body such that the cutout of the service body is aligned with the fill opening of the fill housing. The mounting flange 52 includes a plurality of protrusions 79 projecting from the mounting flange 52 toward the tank end 51. In the illustrated embodiment, the mounting flange 52 includes four protrusions 79 with one at each corner. Each protrusion 79 is hollow and includes a female threaded surface 80 therein for engagingly receiving the fasteners 72 of the cover assembly 43 to secure the frame 70 of the cover assembly 43 to the fill housing 41 with the panel of the service body therebetween such that the fill port 74 of the frame 70, the cutout service body, and the fill opening 53 of the fill housing 41 are aligned to permit a suitable gas tank nozzle to extend therethrough.

The shroud portion 55 includes a top 81, the pair of sidewalls 64, and a bottom 82. The sidewalls 64 are in lateral spaced relationship to each other and extend between the top and bottom portions 81, 82. In the illustrated embodiment, the top portion 81 is generally a cylindrical segment and is curved, extending toward the bottom portion 82 in the direction from the fill end 50 toward the tank end 51. The bottom portion 82 is generally a cylindrical segment.

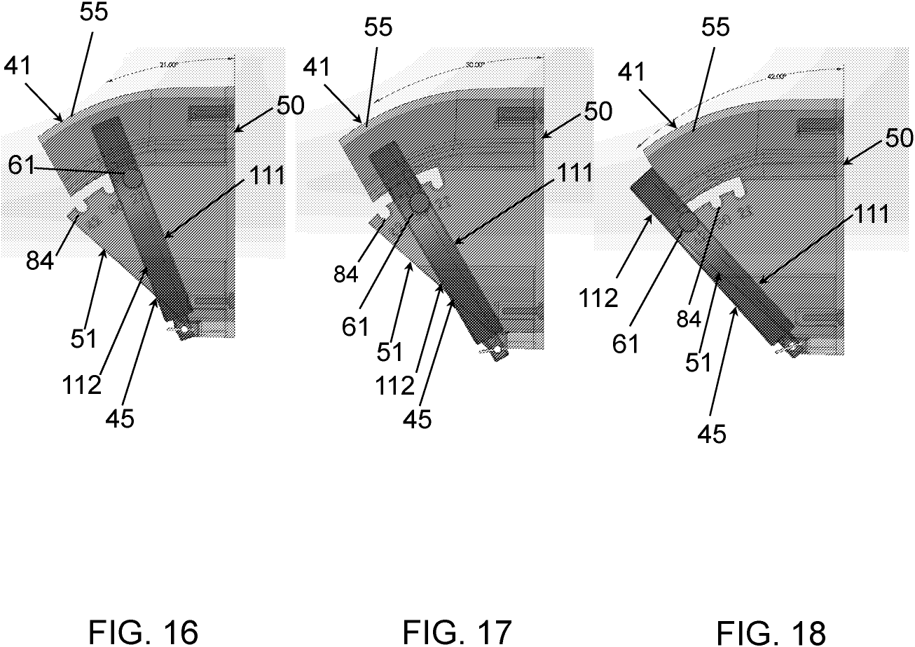

The sidewalls 64 respectively define a series of detents 84 in spaced relationship to each other. The series of detents 84 of the sidewalls 64 are aligned to form pairs of detents configured to cooperate together to secure the mounting plate 45 in one of a plurality of angular tilt positions relative to the fill end 50 (see, e.g., FIGS. 16-18).

In embodiments, the shroud portion 55 can have a different configuration. For example, the shroud portion 55 can be further elongated to allow the fuel fill adaptor assembly to be suitable for use with other vehicles and/or fuel tank arrangements. In embodiments, one or more parts of the shroud 55 can have a different shape and/or size.

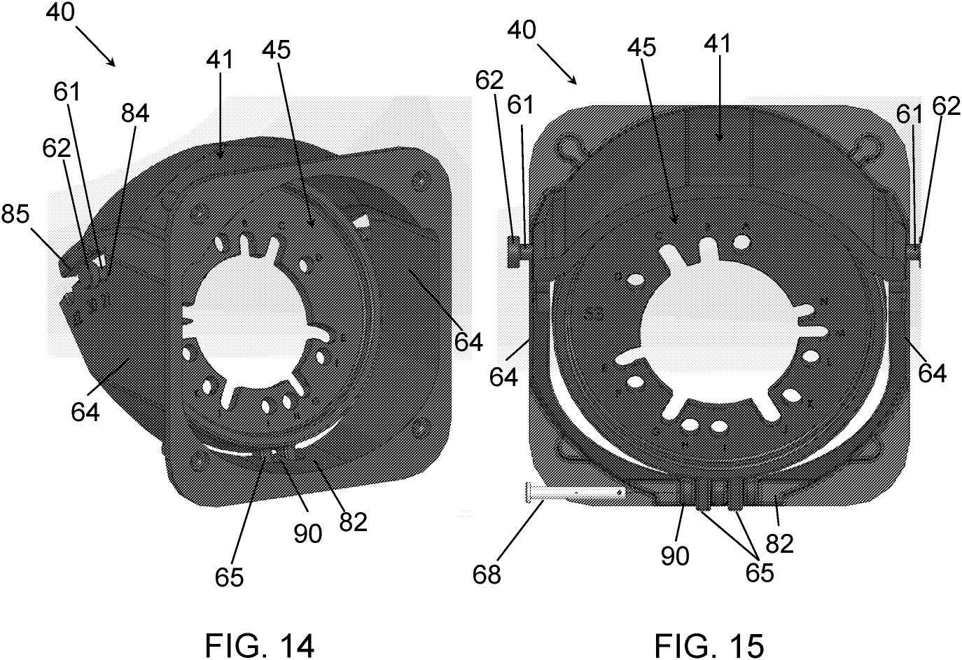

Referring to FIG. 1, the mounting plate 45 positions correspond to the location of the pairs of detents 84. The sidewalls 64 each define a groove 85 therethrough to permit the detent posts 61 projecting from the mounting plate 45 to extend therethrough to position the posts 61 in one of the pairs of detents 84. In the illustrated embodiment, each post 61 of the mounting plate 45 includes a stop flange in the form of the disc 62 extending radially from the post 61 and configured to act as a stop against the sidewall 64 through which the post 61 extends to help capture the mounting plate 45 laterally with respect to the sidewalls 64 of the fill housing 41 (see, e.g., FIGS. 14 and 15).

In embodiments, the number and/or location of the detents defined in the fill housing can be varied. For example, referring to FIG. 3, an embodiment of a fuel fill adaptor assembly 340 constructed according to principles of the present disclosure is shown which includes a fill housing 341 having a single detent 384 defined in each sidewall 364. The fuel fill adaptor assembly 340 can be similar in construction and operation in other respects to the fuel fill adaptor assembly 40 of FIG. 1.

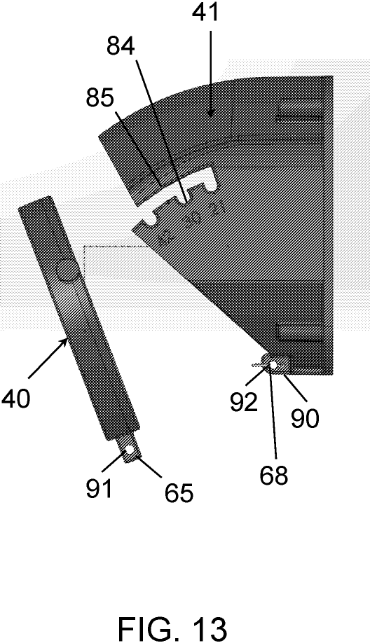

Referring to FIGS. 14 and 15, the bottom portion 82 of the fill housing 41 can include a plurality of mounting tabs 90 in lateral spaced relationship to each other to accommodate therebetween the pair of mounting finger 65s extending from the mounting plate 45. In the illustrated embodiment, the mounting tabs 90 and the mounting fingers 65 each define a through hole. The through holes 91, 92 of the fingers 65 and the mounting tabs 90 are configured to be aligned such that the cotter pin 68 can be inserted therethrough to connect the mounting plate 45 to the fill housing 41 (see also, FIG. 13).

To assemble the fuel fill adaptor assembly 40 (see, e.g., FIGS. 13-15), the posts 61 of the mounting plate 45 can be inserted into the grooves 85 of the fill housing 41 and positioned in a selected pair of detents 84. The mounting plate 45 can be pivoted about the posts 61 such that the fingers 65 of the mounting plate 45 are inserted between the mounting tabs 90 of the fill housing 41. The cotter pin 68 can be inserted through the aligned holes of the mounting tabs 90 and the fingers 65 to secure the mounting plate 45 to the fill housing 41.

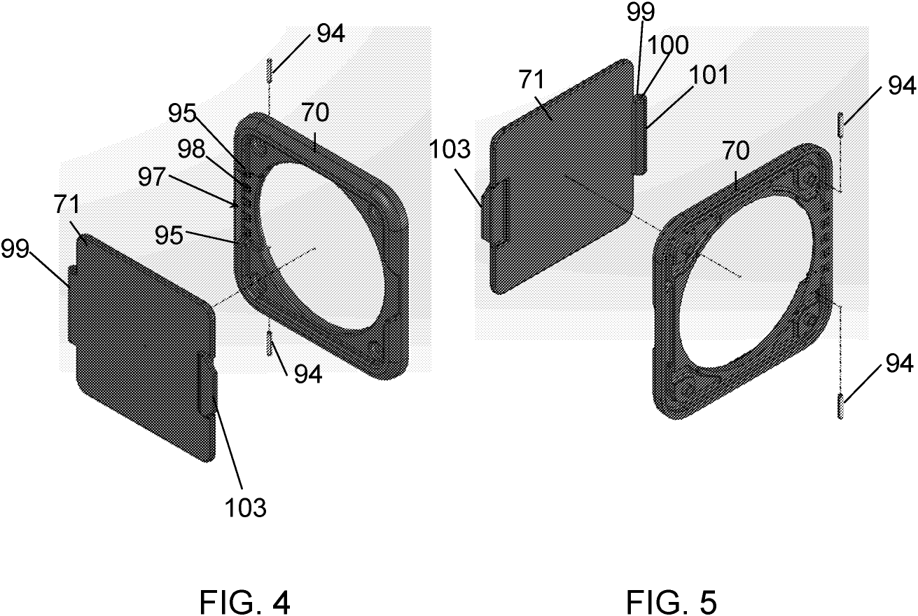

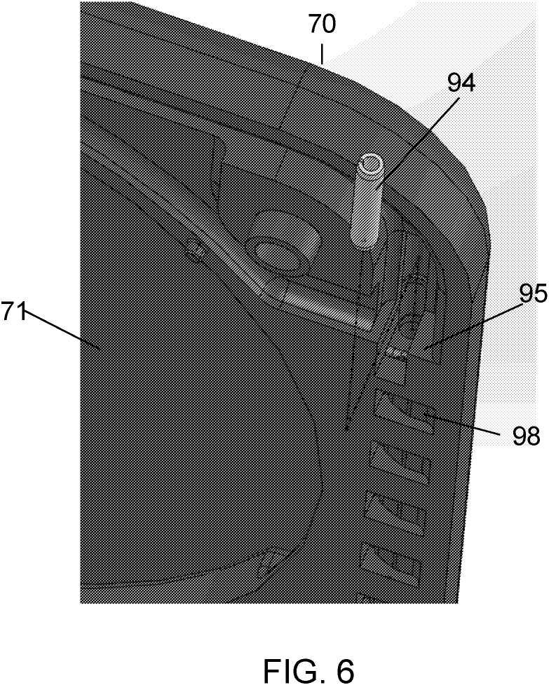

Referring to FIGS. 4-6, in embodiments, at least one of the fill door 71 and the frame 70 include a detent feature configured to retain the fill door 71 in the closed position. In the illustrated embodiment, the fill door 71 is pivotally connected to the frame 70 via a pair of spring pins 94. Referring to FIG. 4, the frame 70 includes a pair of bearing portions 95 that define a recess 97 therebetween. A plurality of resiliently-flexible fingers 98 are disposed in the recess 97 and project outwardly from the frame 70. The fill door 71 includes a hinge knuckle 99 having a blind bore 100 defined in each end thereof and defines an external detent 101 (see FIGS. 5 and 8).

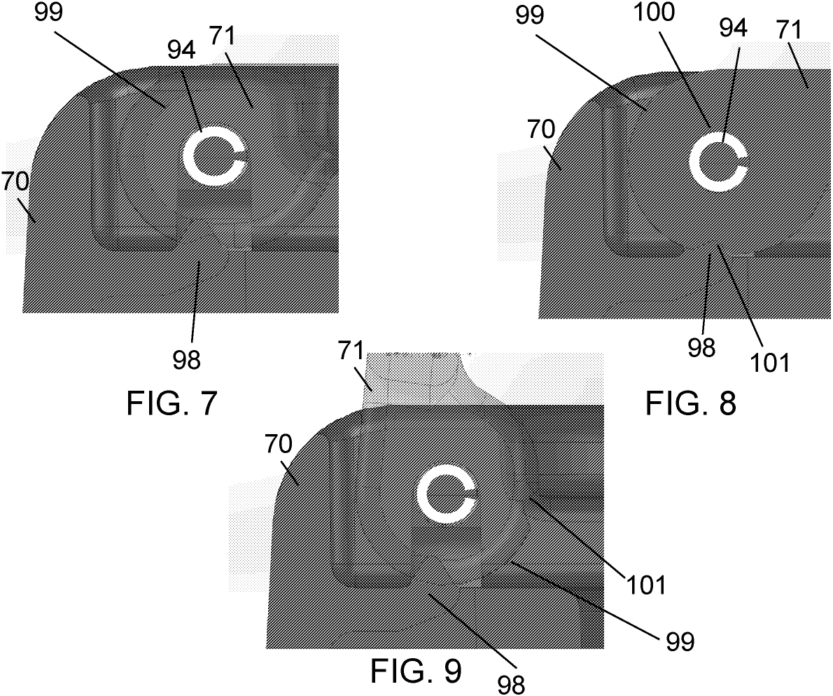

Referring to FIGS. 7 and 8, the spring pins 94 can be inserted through bores in the bearing portions 95 of the frame 70 and into the blind bores 100 of the hinge knuckle 99 of the fill door 71 to pivotally secure the fill door 71 to the frame 70. The fingers 98 of the frame 70 and the external detent 101 of the fill door 71 are configured to interact with each other to help retain the fill door 71 in the closed position.

Referring to FIG. 9, when the fill door 71 is moved from the closed position, the fingers 98 of the frame 70 can flex to permit relative pivotal movement of the fill door 71 and the frame 70. The fingers 98 move out of the external detent 101 of the fill door 71 and ride along the external surface of the hinge knuckle 99 of the fill door 71 as the fill door 71 pivots to one of a range of open positions. Referring to FIGS. 4 and 5, the fill door 71 includes a gripping portion 103 extending from a side in opposing relationship to the side of the fill door 71 including the hinge knuckle 99 to facilitate movement of the fill door 71 over the range of travel between the closed position and the fully open position.

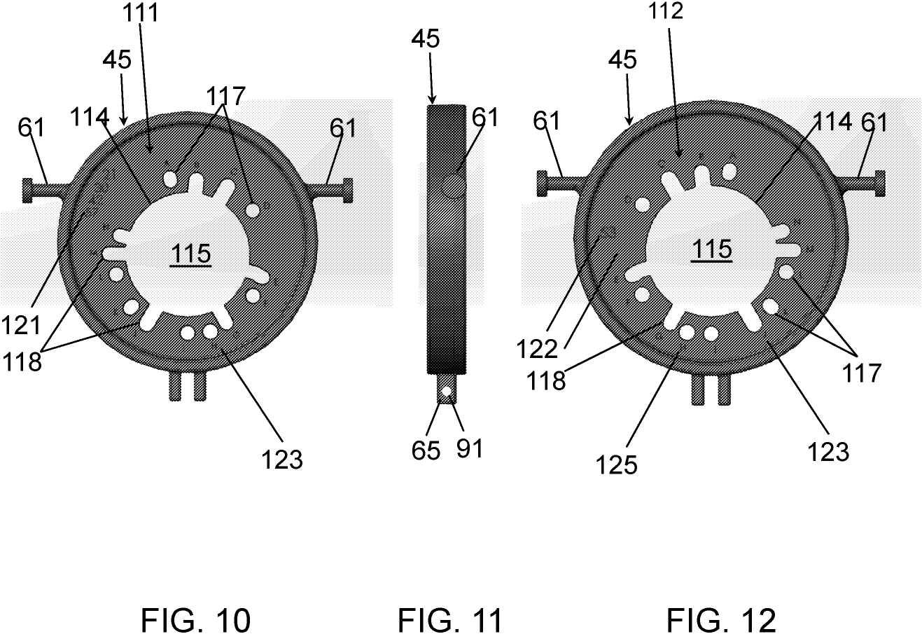

Referring to FIGS. 10-12, the mounting plate 45 includes a first mounting face 111 (FIG. 10) and a second mounting face 112 (FIG. 12). The mounting plate 45 includes an internal perimeter 114 defining a fill neck aperture 115 through the first and second mounting faces 111, 112 that is configured to be placed in fluid communication with a plurality of different fill necks of different fuel tank arrangements. In embodiments, the mounting plate 45 defines a plurality of mounting apertures including at least one of a series of mounting holes 117 and a series of mounting grooves 118 through the first and second mounting faces 111, 112 and disposed around the internal perimeter 114 of the fill neck aperture 115 which are configured to help connect different types of terminal portions of a fuel tank assembly of a vehicle.

In the illustrated embodiment, the mounting plate defines a series of mounting apertures in the form of mounting holes 117 and mounting grooves 118 through the first and second mounting faces 111, 112 and disposed around the perimeter 114 of the fill neck aperture 115. The mounting holes 117 and mounting grooves 118 can be configured to permit the connection of a variety of different fill necks having different mounting structures and configurations. In use, a given fill neck can be aligned with two or more of the mounting apertures 117, 118 to permit the fill neck to be secured to the mounting plate 45 via suitable fasteners.

Referring to FIG. 11, in the illustrated embodiment, the detent posts 61 of the mounting plate 45 are in offset relationship to the holes 91 of the mounting fingers 65 such that the mounting plate 45 is asymmetrical and has a mounting polarity. In use, the orientation of the mounting faces 111, 112 can be flipped in order to change the angular relationship of the mounting plate 45 to the fill end 50 of the fill housing 41 by a fixed angular amount (such as by four degrees as in the illustrated embodiment), which is a function of the offset relationship between the detent posts 61 and the through holes 91 of the mounting fingers 65. In embodiments, the geometric relationship between the posts 61 and the mounting fingers 65 of the mounting plate 45 can be varied to provide a different incremental angular adjustment feature.

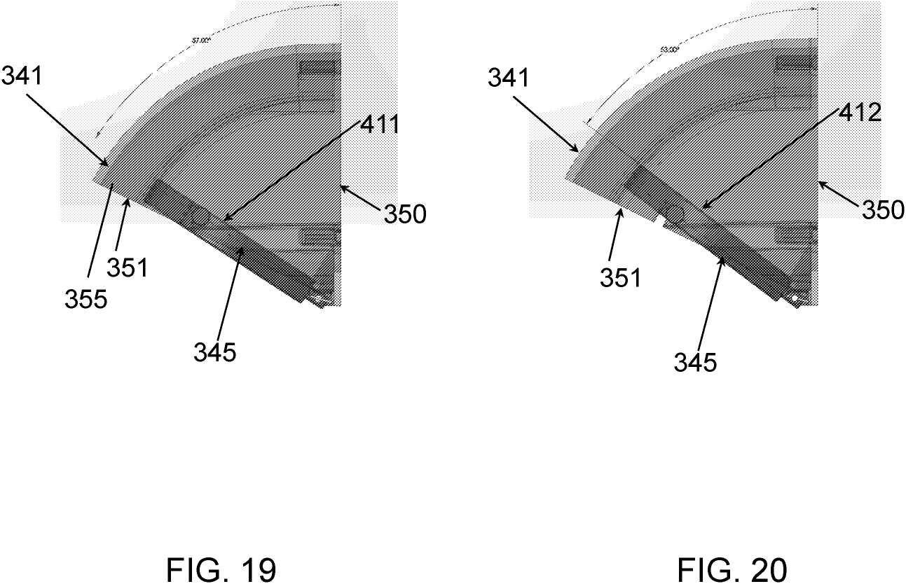

For example, referring to FIG. 19, the mounting plate 345 is connected to the fill housing 341 such that the first mounting face 411 of the mounting plate 345 faces toward the fill end 350, and away from the tank end 351, of the fill housing 341 such that the mounting plate 345 is disposed at a given tilt angle with respect to the fill end 350 of the fill housing 341 (fifty-seven degrees in the illustrated embodiment). Referring to FIG. 20, the mounting plate 345 is connected to the fill housing 341 such that the second face 412 of the mounting plate 345 faces toward the fill end 350, and away from the tank end 351, of the fill housing 341 such that the mounting plate 345 is disposed at a tilt angle with respect to the fill end 350 of the fill housing 341, which is smaller than the tilt angle shown in the mounting arrangement in FIG. 19 (fifty-three degrees in the illustrated embodiment).

Referring to FIGS. 16-18, the mounting plate 45 is connected to the fill housing 41 such that the first mounting face 111 of the mounting plate 45 faces toward the fill end 50, and away from the tank end 51, of the fill housing 41 and the posts 61 of the mounting plate 45 are respectively placed in one pair of the series of detents 84 defined in the fill housing 41 such that the mounting plate 45 is disposed at one of three different tilt angles with respect to the fill end 50 of the fill housing 41 (twenty-one degrees, thirty degrees, and forty-two degrees in the illustrated embodiment). The mounting plate 45 can also be mounted to the fill housing 41 such that the second face 112 of the mounting plate 45 faces toward the fill end 50, and away from the tank end 51, of the fill housing 41 so that the tilt angle corresponding to the series of detents 84 is correspondingly decreased by the incremental angular adjustment feature provided by the offset posts 61.

Referring to FIG. 1, in embodiments, the mounting plate 45 can mounted to the fill housing 41 in one of a variety of different mounting positions. Referring to FIGS. 10 and 12, in embodiments, at least one of the first mounting face 111 and the second mounting face 112 includes indicia 121, 122, 123 configured to indicate at least one of a tilt position indicating the mounting plate 45 is in a specified angular relationship with respect to the fill housing 41 and a fill neck mounting arrangement indicating at least one mounting aperture or mounting groove suitable for connecting a specified fill neck.

In the illustrated embodiment, the first mounting face 111 of the mounting plate 45 and the sidewalls of the fill housing 41 include mounting tilt indicia 121 comprising a series of numbers (“21,” “30,” “42,”, and “57”) that an installer can use when securing the mounting plate to the fill housing to verify the mounting plate is in a desired angular relationship with respect to the fill end of the fill housing. In the illustrated embodiment, the mounting tilt indicia 121 on the first mounting face 111 of the mounting plate 45 corresponds to the tilt angles of the mounting plate 45 that are available when the first mounting face 111 of the mounting plate 45 is oriented toward the fill end 50. In the illustrated embodiment, the “57” mounting tilt indicia 121 can be used when mounting the mounting plate 45 to the fill housing 341 of FIG. 3.

Referring to FIG. 1, the sidewalls 64 of the fill housing 41 also include at least some of the same mounting tilt indicia 121 found on the first mounting face 111 of the mounting plate 45 (“21,” “30,” and “42”) respectively positioned adjacent a given one of the series of detents 84 defined through the sidewalls 64 of the fill housing 41. In use, when connecting the mounting plate 45 to the fill housing 41, the installer can place the posts 61 of the mounting plate 45 in the pair of detents 84 associated with a desired one of the tilt angles with the first mounting face 111 of the mounting plate 45 positioned toward the fill end 50.

Referring to FIG. 12, the second mounting face 112 of the mounting plate 45 includes mounting tilt indicia a number 122 (“53”) that an installer can use when securing the mounting plate 45 to the fill housing 341 of FIG. 3 to verify the mounting plate 45 is in a desired angular relationship with respect to the fill end 350 of the fill housing 341. In the illustrated embodiment, the mounting tilt indicia 122 on the second mounting face 112 of the mounting plate 45 corresponds to the tilt angle of the mounting plate 45 when the second mounting face 112 of the mounting plate 45 is oriented toward the fill end 350 of the fill housing 341 of FIG. 3.

Referring to FIG. 10, the mounting plate 45 is configured to be connectable to at least two different fill necks having different mounting configurations. The first mounting face 111 includes fill neck mounting indicia 123 comprising a series of letters (“A” through “N” in the illustrated embodiment) respectively positioned adjacent a given one of the mounting apertures 117, 118 defined through the mounting faces 111, 112 of the mounting plate 45. Referring to FIG. 12, in embodiments, the second mounting face 112 can include the same fill neck mounting indicia 123 to respectively indicate the same mounting apertures 117, 118 as indicated on the first mounting face 111. When mounting a particular fill neck, an installer can use the fill neck mounting indicia 123 to connect the particular fill neck to the mounting plate 45 according to a predetermined set of mounting data compiled for a variety of different fill necks.

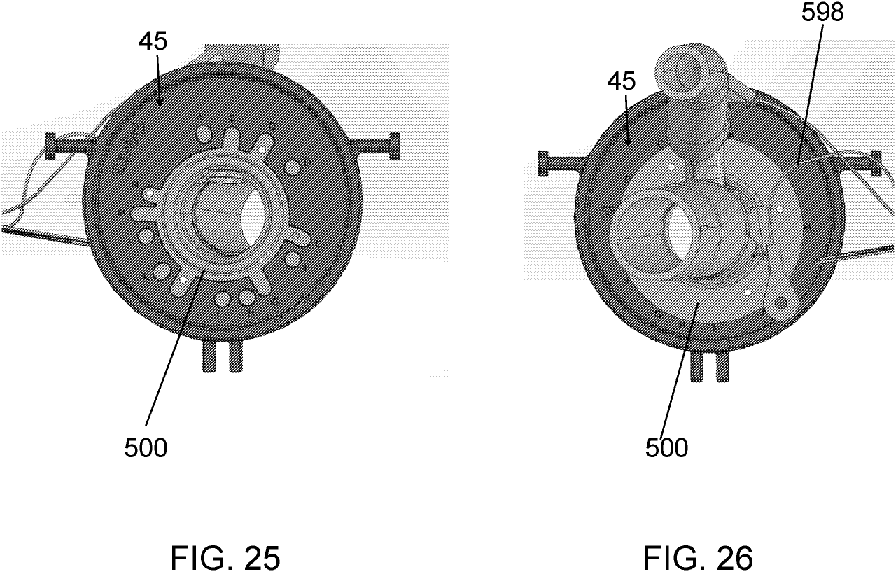

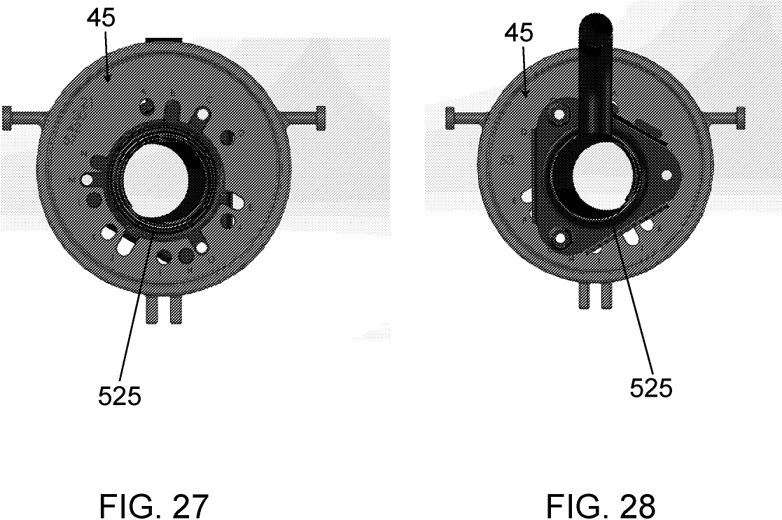

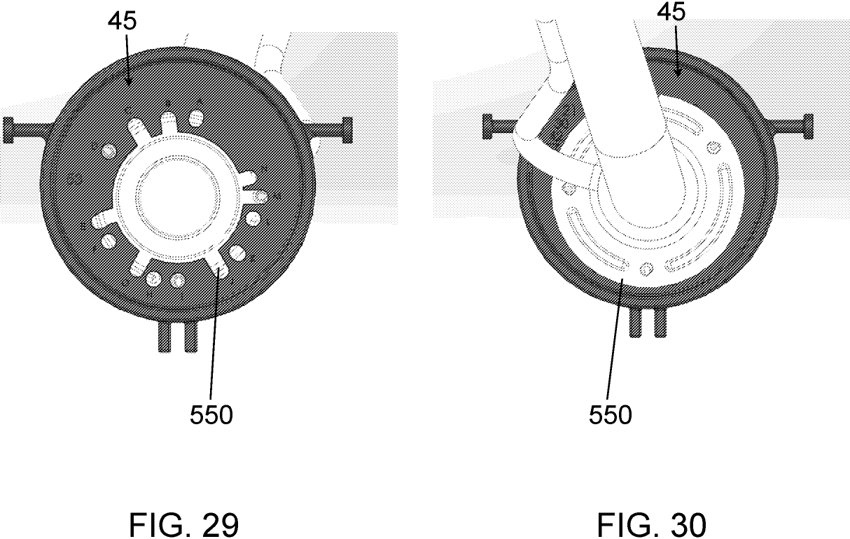

For example, referring to FIGS. 25 and 26, a first fill neck 500 is connected to mounting plate 45 using mounting apertures “C,” “E,” “J,” and “N.” Referring to FIGS. 27 and 28, a second fill neck 525 is connected to mounting plate 45 using mounting apertures “C,” “G,” and “M.” Referring to FIGS. 29 and 30, a third fill neck 550 is connected to the mounting plate 45 using mounting apertures “D,” “I,” and “M.” In embodiments, the mounting data for a predetermined set of different fill necks and/or vehicles can be compiled and provided along with the fuel fill adaptor assembly,

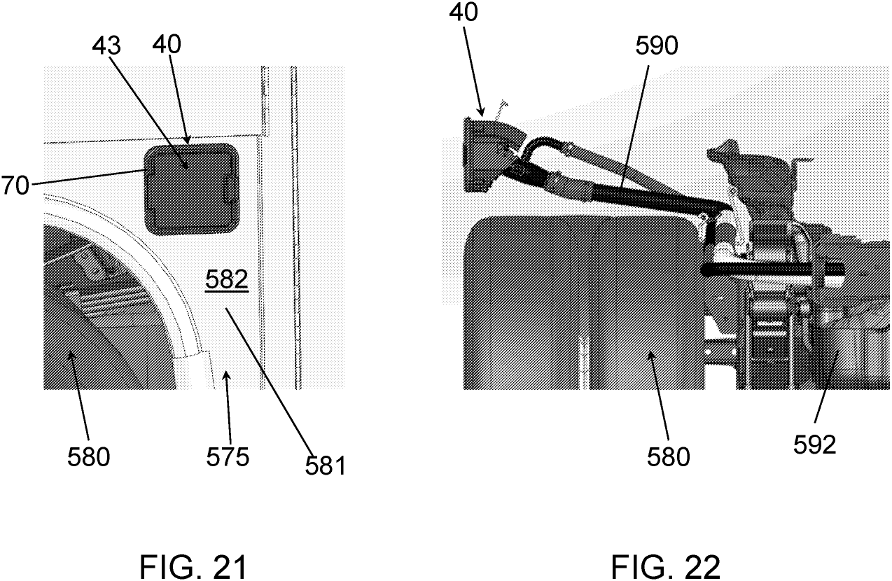

Referring to FIGS. 21 and 22, the fuel fill adaptor assembly 40 of FIG. 1 is mounted to a service body 575, which in turn is installed to a vehicle 580. The service body panel 581 has an interior surface and an exterior surface 582. The service body panel 581 defines a cutout extending therethrough between the exterior surface 582 and the interior surface.

The cover assembly 43 is configured such that it covers the cutout made in the panel 581 of the service body 575. The frame 70 is attached to the mounting flange of the fill housing such that the service body panel 581 is interposed between the frame 70 and the mounting flange. The fuel fill adaptor assembly 40 is connected to a fuel fill line 590 of a fuel tank 592 of the vehicle 580 such that a gas pump nozzle can dispense fuel therefrom and be fluidly conveyed to the fuel tank 592.

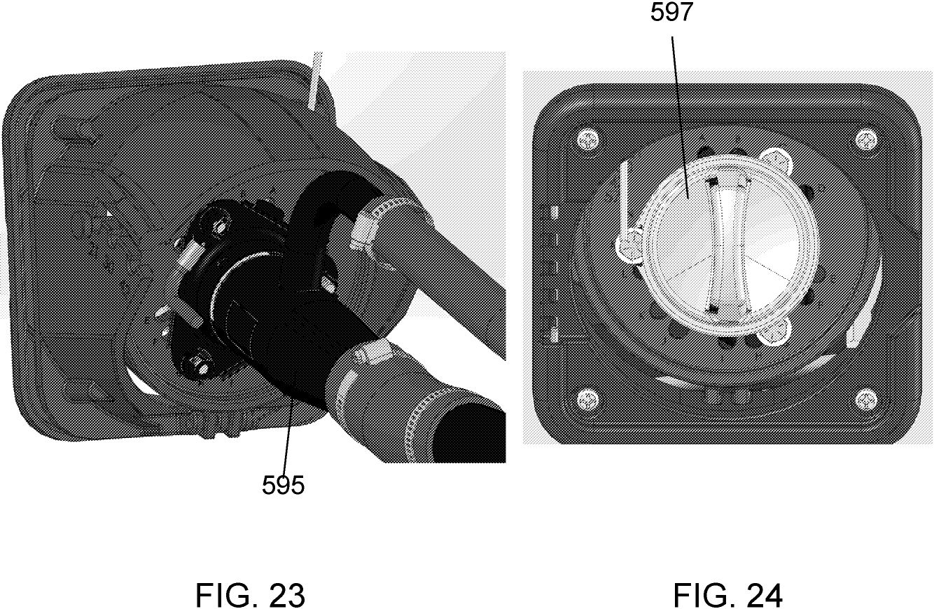

Referring to FIGS. 23 and 24, in embodiments, the fill neck 595 can be configured to receive a cap 597 to occlude the fuel passage therethrough. The cap 597 can be removably secured to the fill neck 595 using any suitable technique, such as mating threads, for example. Referring to FIG. 26, in embodiments, a suitable grounding connector 598 can be used to help electrically ground the system according to prevailing standards.

In embodiments, the components of the fuel fill adaptor assembly can be made from any suitable material and made using any suitable technique. For example, in embodiments, components of the fuel fill adaptor assembly can be made from a suitable plastic using an injection molding process. In embodiments, components of the fuel fill adaptor assembly can be made from a suitable commercially-available plastic, such as those available from DuPont de Nemours, Inc. (“DuPont”) of Wilmington, Delaware, including Zytel® ST801 nylon resin, for example.

In embodiments, the fuel fill adaptor assembly can have any configuration suitable for the intended application(s) of the service body for which it is provided and for a predetermined set of different fuel tank connection structures. In embodiments, the fuel fill adaptor assembly can be made from a plurality of components that are assembled together to provide the functionality described herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A fuel fill adaptor assembly comprising:
a fill housing, the fill housing defining a fill end, an interior cavity, and a tank end, the fill end includes a mounting flange defining a fill opening in communication with the interior cavity, the tank end defines a mounting opening in communication with the interior cavity;
a cover assembly for selectively preventing access to the interior cavity of the fill housing via the fill opening; and
a mounting plate, the mounting plate mounted to the fill housing adjacent the tank end in one of a plurality of mounting positions, the mounting plate configured to be connectable to at least two types of a terminal portion of a fuel tank assembly having different mounting configurations.

2. The fuel fill adaptor assembly according to claim 1, wherein the mounting plate is configured to be mounted to the fill housing adjacent the tank end of the housing in one of a plurality of different mounting positions.

3. The fuel fill adaptor assembly according to claim 1, wherein the fill housing includes a shroud portion extending between the fill end and the tank end, the shroud portion extending from the mounting flange of the fill end to the tank end and defines the interior cavity.

4. The fuel fill adaptor assembly according to claim 3, wherein the mounting opening is configured to accommodate the mounting plate therethrough.

5. The fuel fill adaptor assembly according to claim 3, wherein the mounting flange of the fill end defines a substantially planar mounting surface, and the mounting flange includes a plurality of protrusions projecting from the mounting flange toward the tank end and including a female threaded surface therein for engagingly receiving a fastener therein.

6. The fuel fill adaptor assembly according to claim 3, wherein the shroud portion includes a top, a pair of sidewalls, and a bottom, the sidewalls being in lateral spaced relationship to each other and extending between the bottom and top portions.

7. The fuel fill adaptor assembly according to claim 6, wherein each of the sidewalls of the shroud portion respectively defines a series of detents in spaced relationship to each other, the series of detents of the sidewalls being aligned to form pairs of detents configured to cooperate together to secure the mounting plate in one of a plurality of angular tilt positions relative to the fill end.

8. The fuel fill adaptor assembly according to claim 7, wherein the mounting plate includes a pair of detent posts projecting therefrom, and wherein each of the sidewalls of the shroud portion respectively defines a detent groove including the respective series of detents therethrough to permit the detent posts to extend respectively therethrough to position the posts in one of the pairs of detents.

9. The fuel fill adaptor assembly according to claim 8, wherein, each of the detent posts of the mounting plate includes a disc extending radially from the post and configured to act as a stop against the sidewall through which the post extends to capture the mounting plate laterally with respect to the sidewalls of the fill housing.

10. The fuel fill adaptor assembly according to claim 7, wherein the mounting plate includes a plurality of mounting fingers extending therefrom, and wherein the bottom portion of the fill housing includes a plurality of mounting tabs in lateral spaced relationship to each other to accommodate therebetween the mounting fingers of the mounting plate.

11. The fuel fill adaptor assembly according to claim 10, wherein the mounting tabs and the mounting fingers each define a through hole, the through holes of the mounting tabs and the fingers are aligned, the assembly further comprising:
a pin extending through the through holes to pivotally connect the mounting plate to the fill housing.

12. The fuel fill adaptor assembly according to claim 1, wherein the mounting plate includes a first mounting face and a second mounting face, the mounting plate includes an internal perimeter defining a fill neck aperture through the first and second mounting faces configured to be placed in fluid communication with a plurality of different fill necks of different fuel tank arrangements.

13. The fuel fill adaptor assembly according to claim 12, wherein the mounting plate defines a plurality of mounting apertures including at least one of a series of mounting holes and a series of mounting grooves through the first and second mounting faces and disposed around the internal perimeter of the fill neck aperture.

14. The fuel fill adaptor assembly according to claim 13, wherein at least one of the first mounting face and the second mounting face includes indicia configured to indicate at least one of a tilt position indicating the mounting plate is in a specified angular relationship with respect to the fill housing and a fill neck mounting arrangement indicating at least one mounting hole or mounting groove suitable for connecting a specified fill neck.

15. The fuel fill adaptor assembly according to claim 12, wherein the mounting plate includes a pair of detent posts projecting therefrom, and wherein the fill housing defines a respective pair of detent grooves therethrough including a series of detents, the detent grooves configured to permit the detent posts to extend respectively therethrough to position the detent posts in one of the pairs of detents.

16. The fuel fill adaptor assembly according to claim 15, wherein the mounting plate includes a plurality of mounting fingers extending therefrom, wherein the bottom portion of the fill housing includes a plurality of mounting tabs in lateral spaced relationship to each other to accommodate therebetween the mounting fingers of the mounting plate, wherein the mounting tabs and the mounting fingers each define a through hole, the through holes of the mounting tabs and the fingers are aligned, the assembly further comprising:
a pin extending through the through holes to pivotally connect the mounting plate to the fill housing.

17. The fuel fill adaptor assembly according to claim 16, wherein the detent posts of the mounting plate are in offset relationship to the through holes of the mounting fingers.

18. The fuel fill adaptor assembly according to claim 1, wherein the cover assembly includes a frame, a fill door pivotally connected to the frame, and a plurality of fasteners for securing the frame to the fill housing, the frame defines a central fill port therethrough, the fill door is pivotally movable over a range of travel between a closed position in which the fill port is occluded and access to the interior cavity of the fill housing via the fill opening is blocked and an open position in which the door is moved away from the fill port such that the interior cavity of the fill housing is accessible through the fill opening.

19. The fuel fill adaptor assembly according to claim 12, wherein at least one of the fill door and the frame include a detent feature configured to retain the fill door in the closed position.

20. A service body for a vehicle comprising:
a service body panel, the service body panel having an interior surface and an exterior surface with a cutout extending therethrough;
a fuel fill adaptor assembly, the fuel fill adaptor assembly including:
a fill housing, the fill housing defining a fill end, an interior cavity, and a tank end, the fill end includes a mounting flange defining a fill opening in communication with the interior cavity, the tank end defines a mounting opening in communication with the interior cavity,
a cover assembly for selectively preventing access to the interior cavity of the fill housing via the fill opening, and
a mounting plate, the mounting plate mounted to the fill housing adjacent the tank end in one of a plurality of mounting positions, the mounting plate configured to be connectable to at least two types of a terminal portion of a fuel tank assembly having different mounting configurations;
wherein the cover assembly includes a frame and a fill door pivotally connected to the frame, the frame being attached to the mounting flange of the fill housing such that the service body panel is interposed between the frame and the mounting flange, the frame defines a central fill port therethrough, the central fill port being aligned with the cutout, the fill door being pivotally movable over a range of travel between a closed position in which the cutout and the fill port are occluded and access to the interior cavity of the fill housing via the fill opening is blocked and an open position in which the door is moved away from the fill port such that the interior cavity of the fill housing is accessible through the fill opening and the cutout.
